(19) United States
(12) Patent Application Publication
(10) Pub. No.: US 2019/0049747 A1
(43) Pub. Date: Feb. 14, 2019

(54) Eyewear Nose Pad Foam Cover

(71) Applicant: Sandeep Singh, Parsippany, NJ (US)

(72) Inventor: Sandeep Singh, Parsippany, NJ (US)

(21) Appl. No.: 15/676,996

(22) Filed: Aug. 14, 2017

(51) Int. Cl. G02C 5/12

(52) U.S. Cl. CPC G02C 5/12

(57) ABSTRACT

A foam cover that the eyewear nose pad can slide into.

### BACKGROUND OF THE INVENTION

The present invention is in the field of eyewear.

Eyewear can cause pressure and discomfort on the nose. Prolonged wear can cause dark patches on the part of the skin which was under the nose pads. Due to the oil and sweat between the nose pad and skin, occasionally the eyewear slides and does not stay in position.

### SUMMARY OF THE INVENTION

The present invention is an eyewear nose pad foam cover for users to cover the nose pads with the foam cover.

### BRIEF DESCRIPTION OF THE DRAWING

FIG. 1 is a top view of a nose pad foam cover of the present invention;

FIG. 2 is a bottom view of a nose pad foam cover of the present invention;

FIG. 3 is a side view of a nose pad foam cover of the present invention;

FIG. 4 is a view of a nose pad foam cover of the present invention when used over a nose pad of eyewear as shown in [A] of the FIG. 4;

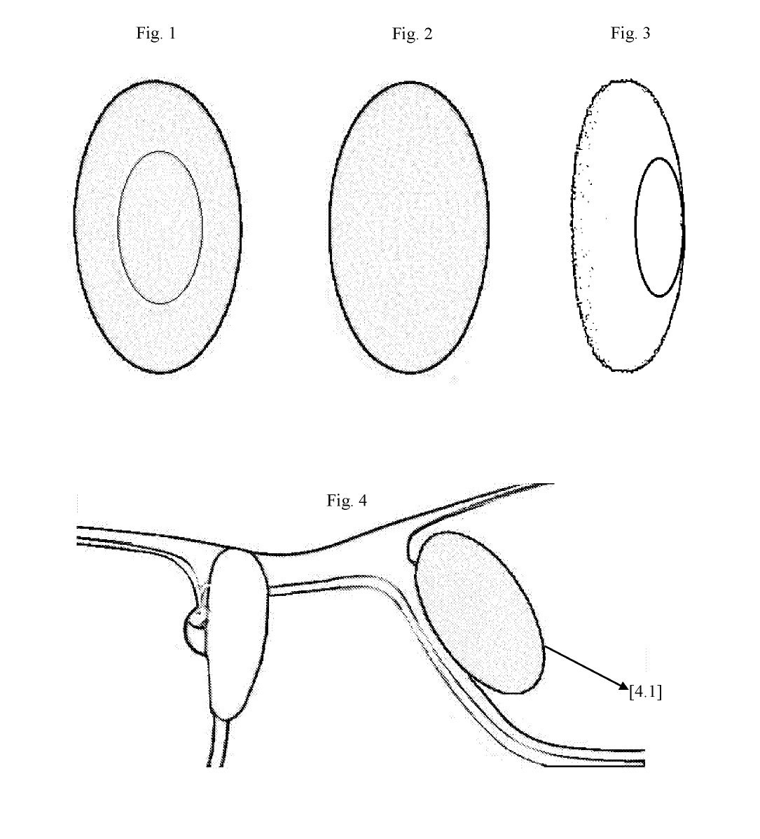

1. Referring now to the invention as shown in FIG. 1, FIG. 2 and FIG. 3 shows a foam cover that the eyewear nose pad can slide into as shown in [4.1] of the FIG. 4.

2. Referring to the nose pad foam cover of claim 1, the foam cover is sufficiently wide and long to cover the nose pad easily.

3. Referring to the construction of the article of claim 2, is made up of memory foam or polyurethane foam or any other foam of any color.

4. Referring to the article of claim 3, the nose pad foam cover is oval hollow shaped, that has an opening at the top center through which the nose pad can slide into the foam cover.

5. The advantages of the article of claim 4, is that due to the soft nature of the foam cover, it eases of the pressure of the eyewear on the nose and prevent from forming dark patches on the nose skin. Nose pad foam cover provide grip to slipping glasses and can be easily replaced.

6. In broad embodiment the article of claim 5, is a foam cover that covers the nose pad of eyewear.
